(19) United States
(12) Patent Application Publication
(10) Pub. No.: US 2024/0203637 A1
(43) Pub. Date: Jun. 20, 2024

(54) WINDING ARRANGEMENT FOR TRANSFORMER

(71) Applicant: Murata Manufacturing Co., Ltd., Nagaokakyo-shi (JP)

(72) Inventor: Kapila WARNAKULASURIYA, Milton Keynes (GB)

(21) Appl. No.: 18/538,741

(22) Filed: Dec. 13, 2023

(30) Foreign Application Priority Data
Dec. 14, 2022 (GB) 2218861.9

(51) Int. Cl. H01F 27/28; H01F 27/24; H01F 27/30

(52) U.S. Cl. CPC H01F 27/2823; H01F 27/24; H01F 27/306

(57) ABSTRACT

A winding arrangement for an electrical transformer includes a first coil including a first section and a second section. The first and the second sections of the first coil each include one or more sets of turns having a first diameter and one or more sets of turns having a second diameter smaller than the first diameter. The winding arrangement includes a first winding axis and a second winding axis parallel or substantially parallel to the first winding axis. A first group of the sets of turns of the first and the second sections of the first coil are arranged around the first winding axis, and a second group of the sets of turns of the first and the second sections of the first coil are arranged around the second winding axis.

### CROSS REFERENCE TO RELATED APPLICATIONS

This application claims priority to United Kingdom Patent Application No. 2218861.9 filed on Dec. 14, 2022. The entire contents of this application are hereby incorporated herein by reference.

### BACKGROUND OF THE INVENTION

### 1. Field of the Invention

This application relates to winding arrangements for an electrical transformer and electrical transformers including winding arrangements. In particular, this application relates to winding arrangements that achieve low losses and desirable inductance properties.

### 2. Description of the Related Art

Murata Manufacturing Co., Ltd.'s pdqb winding technology makes it possible to achieve the theoretically minimum level of high-frequency conductor losses in high-power, high-frequency transformers (which typically have operating parameters above about 10 kW and about 10 kHz). Murata Manufacturing Co., Ltd.'s pdqb technology is described in UK patent publication GB2574481A, international patent publication WO2019/234453 A1, and UK patent application number GB2206600.5, which are hereby incorporated by reference in their entirety.

The above-mentioned technology allows for construction of high-power, high-frequency transformers with a very high efficiency, as well as a very low leakage level, which is desirable in many cases. However, in some cases it can be beneficial to incorporate an additional inductance into a transformer. Typical solutions to achieve an additional inductance include the use of a separate inductor, which therefore leads to additional components being required. Alternatively, a loose litz wire construction can be used to provide additional inductance; however, this solution results in a low level of precision.

It is desirable to provide an improved winding arrangement for a transformer having reduced losses and an optimized additional inductance.

### SUMMARY OF THE INVENTION

According to a first example embodiment of the present invention, a winding arrangement for an electrical transformer is provided. The winding arrangement includes a first coil including a first section and a second section. The first and second sections of the first coil each include one or more sets of turns having a first diameter and one or more sets of turns having a second diameter smaller than the second diameter. The winding arrangement includes a first winding axis and a second winding axis parallel or substantially parallel to the first winding axis. A first group of the sets of turns of the first and second sections of the first coil are arranged around the first winding axis, and a second group of the sets of turns of the first and second sections of the first coil are arranged around the second winding axis.

Optionally, the first section and second section of the first coil are electrically connected in parallel.

Optionally, the number of turns with the first diameter in the first section of the first coil is equal to the number of turns with the first diameter in the second section of the first coil, and the number of turns with the second diameter in the first section of the first coil is equal to the number of turns with the second diameter in the second section of the first coil, such that the first and second sections of the first coil have the same length.

Optionally, when viewed along the first and second winding axes, each set of turns of the first section of the first coil having the second diameter is positioned within a respective set of turns of the second section of the first coil having the first diameter, and each set of turns of the second section of the first coil having the second diameter is positioned within a respective set of turns of the first section of the first coil having the first diameter.

Optionally, in the first group of the first coil, the sets of turns having the first diameter and the sets of turns having the second diameter are concentric about the first winding axis, and in the second group of the first coil, the sets of turns having the first diameter and the sets of turns having the second diameter are concentric about the second winding axis.

Optionally, wherein the first and second sections of the first coil alternate between the first group and the second group one or more times along the first coil.

Optionally, the first group and second group of the first coil each include one or more subgroups, and the first and second sections of the first coil alternate between the subgroups of the first group and the subgroups of the second group along the first coil.

Optionally, each subgroup of the first coil includes one set of turns having the first diameter and one set of turns having the second diameter both from the first section of the first coil, and one set of turns having the first diameter and one set of turns having the second diameter both from the second section of the first coil.

Optionally, each subgroup of the first coil includes either one set of turns having the first diameter from the first section of the first coil and one set of turns having the second diameter from the second section the first coil, or one set of turns having the second diameter from the first section of the first coil and one set of turns having the first diameter from the second section the first coil.

Optionally, the number of turns with the first diameter and the number of turns with the second diameter are equal in the first section of the first coil, and the number of turns with the first diameter and the number of turns with the second diameter are equal in the second section of the first coil.

Optionally, the winding direction of the first group of the first coil around the first winding axis is in the opposite direction to the winding direction of the second group of the first coil around the second winding axis.

Optionally, the winding arrangement further includes: a second coil having a first section and a second section. The first and second sections of the second coil each include one or more sets of turns having the first diameter and one or more sets of turns having the second diameter. A first group of the sets of turns of the first and second sections of the second coil are arranged around the first winding axis, and a second group of the sets of turns of the first and second sections of the second coil are arranged around the second winding axis.

Optionally, the first section and second section of the second coil are electrically connected in parallel.

Optionally, the number of turns with the first diameter in the first section of the second coil is equal to the number of turns with the first diameter in the second section of the second coil, and the number of turns with the second diameter in the first section of the second coil is equal to the number of turns with the second diameter in the second section of the second coil, such that the first and second sections of the second coil have the same length.

Optionally, when viewed along the first and second winding axes, each set of turns of the first section of the second coil having the second diameter is positioned within a respective set of turns of the second section of the second coil having the first diameter, and each set of turns of the second section of the second coil having the second diameter is positioned within a respective set of turns of the first section of the second coil having the first diameter.

Optionally, in the first group of the second coil, the sets of turns having the first diameter and the sets of turns having the second diameter are concentric about the first winding axis, and in the second group of the second coil, the sets of turns having the first diameter and the sets of turns having the second diameter are concentric about the second winding axis.

Optionally, the first and second sections of the second coil alternate between the first group and the second group one or more times along the second coil.

Optionally, the first group and second group of the second coil each include one or more subgroups, and the first and second sections of the second coil alternate between the subgroups of the first group and the subgroups of the second group along the second coil.

Optionally, each subgroup of the second coil includes one set of turns having the first diameter and one set of turns having the second diameter both from the first section of the second coil, and one set of turns having the first diameter and one set of turns having the second diameter both from the second section of the second coil.

Optionally, each subgroup of the second coil includes either: one set of turns having the first diameter from the first section of the second coil and one set of turns having the second diameter from the second section the second coil; or one set of turns having the second diameter from the first section of the second coil and one set of turns having the first diameter from the second section the second coil.

Optionally, the number of turns with the first diameter and the number of turns with the second diameter is equal in the first section of the second coil, and the number of turns with the first diameter and the number of turns with the second diameter is equal in the second section of the second coil.

Optionally, the winding direction of the first group of the second coil around the first winding axis is in the opposite direction to the winding direction of the second group of the second coil around the second winding axis.

Optionally, the first and second coils are interwound such that the subgroups of the first coil and the subgroups of the second coil alternate along both the first winding axis and the second winding axis.

Optionally, the first coil and the second coil fully overlap when viewed along the first and second winding axes.

Optionally, either the first and second coils are identical, or the first and second coils are identical other than for the number of turns within the first and second coils.

Optionally, the second coil is rotated by 180° relative to the first coil about either (1) an axis parallel or substantially parallel to the first and second winding axes, or (2) an axis normal or substantially normal to the plane containing the first and second winding axes.

Optionally, each set of turns of the first coil and/or second coil is arranged helically around the first or second winding axis.

Optionally, the turns of the first coil and/or second coil have a rectangular, square, or circular shape about the first or second winding axis.

Optionally, the first coil and/or second coil is formed from aluminum wire.

Optionally, the first coil and/or second coil is formed from flat wire.

Optionally, the first coil and/or second coil is encased in a potting material.

According to a second example embodiment of the present invention, an electrical transformer is provided. The transformer includes a transformer core and the winding arrangement of the first example embodiment arranged around the transformer core.

Optionally, the first winding axis and the second winding axis extend along opposing columns of the transformer core.

The winding arrangement of the first example embodiment has a number of advantages. The turns of wire in the winding arrangement can be densely packed into a small volume, while reducing high frequency conductor losses due the proximity effect. Further, an additional inductance, in the form of a leakage inductance, can be achieved through the arrangement of the windings around two parallel or substantially parallel winding axes. Having an additional inductance is beneficial in various transformer applications, and is achieved in the example embodiments of the present invention without the use of additional inductor components or imprecise litz wire or the like. In some cases, a leakage inductance of higher than 8 pH can be achieved with the example embodiments of the present invention.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 shows a winding arrangement according to an example embodiment of the present invention arranged around a transformer core.

FIG. 2 shows a winding arrangement according to an example embodiment of the present invention in isolation.

FIG. 3 shows a first section of the winding arrangement of FIG. 2.

FIG. 4 shows a second section of the winding arrangement of FIG. 2.

### DETAILED DESCRIPTION OF THE EXAMPLE EMBODIMENTS

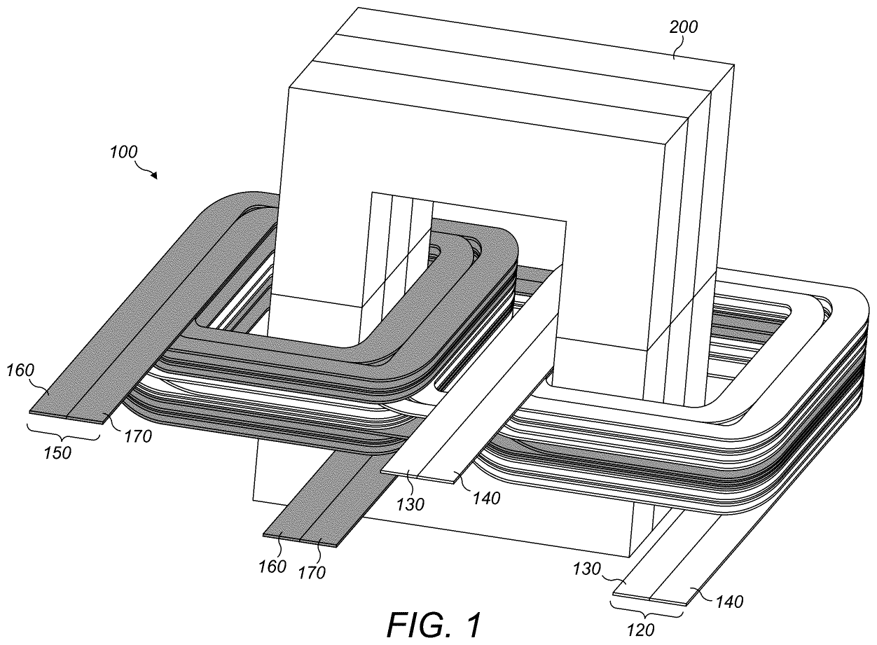

FIG. 1 shows a winding arrangement 100 according to an example embodiment of the present invention arranged around a transformer core 200. The winding arrangement 100 includes a first coil 120 and a second coil 150. The first coil 120 is shown unshaded in FIG. 1, while the second coil 150 includes a light grey shading in FIG. 1.

The first coil 120 includes a first section 130 and a second section 140, which will be described in more detail below. Similarly, the second coil 150 includes a first section 160 and a second section 170.

The first coil 120 and second coil 150 may be used in combination with a transformer core 200 to form a transformer. In general, throughout this description, it will be assumed that the first section 130 of the first coil 120 and the second section 140 of the first coil 120 are electrically connected in parallel to form the first coil 120. Further, it will be assumed that the first section 160 of the second coil 150 and the second section 170 of the second coil 150 are electrically connected in parallel to form the second coil 150. The first coil 120 and the second coil 150 may then be used as the primary coil and secondary coil of a transformer.

However, in alternative example embodiments, the first and second coils 120,150 may include first sections 130,160 and second sections 140,170 that are not electrically connected in parallel.

For example, in some example embodiments, the first coil 120 or second coil 150 may be used in isolation. In this way, the first section 130 of the first coil 120 could form the primary coil of a transformer, and the second section 140 of the first coil 120 could form the secondary coil of a transformer. Similarly, the first section 160 of the second coil 150 could form the primary coil of a transformer, and the second section 170 of the second coil 150 could form the secondary coil of a transformer.

In another example embodiment, one of the first coil 120 or second coil 150 may include its first and second sections connected in parallel, while the other of the first coil 120 or second coil 150 may include its first and second sections not connected in parallel. In this way, a transformer with a primary coil and two secondary coils may be formed.

Throughout this description, the term winding arrangement is used to refer to any specific configuration of a wire that can be used in the windings of a transformer. Therefore, both the first coil and second coil can be considered winding arrangements in isolation. Further, the combination of the first and second coils can also be considered to be a (larger) winding arrangement.

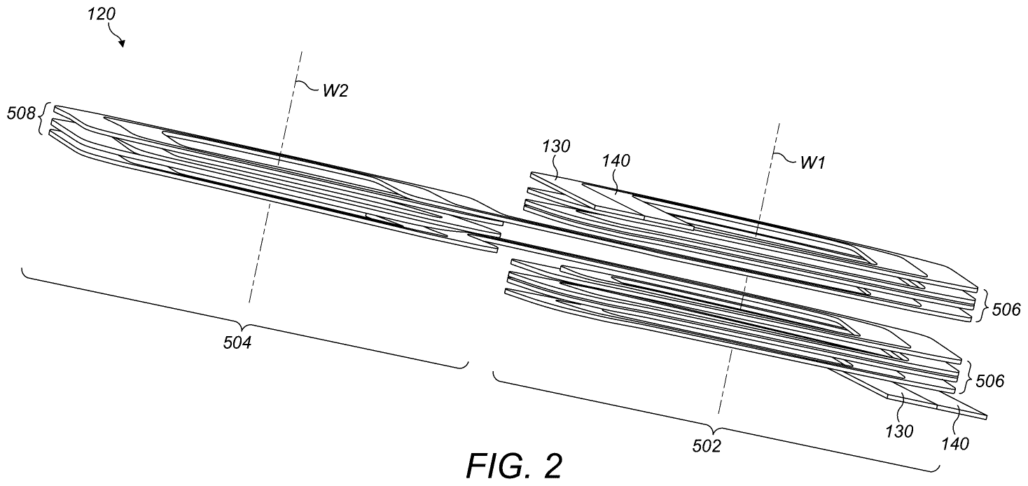

The winding arrangement of the first coil 120 will now be described in further detail in relation to FIGS. 2 to 4.

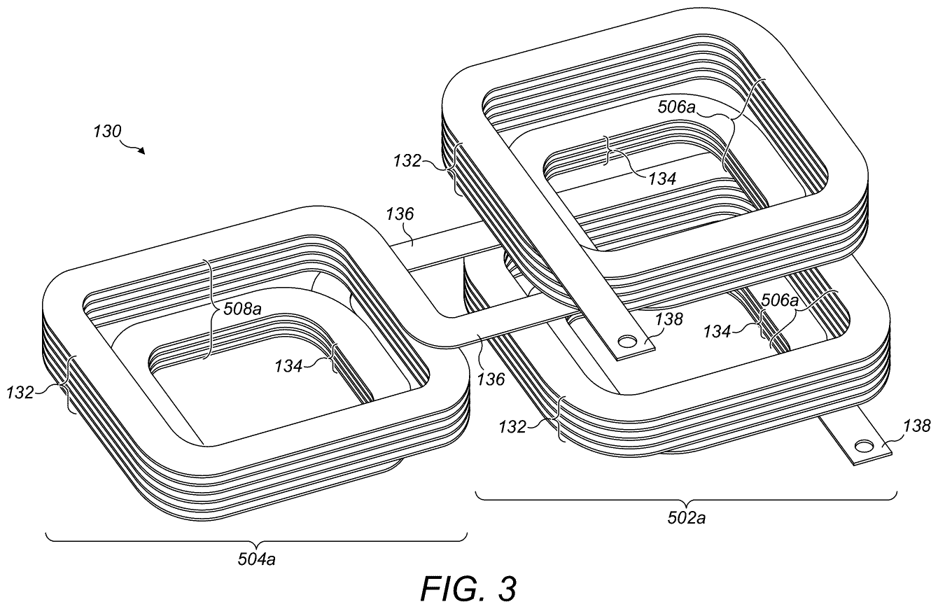

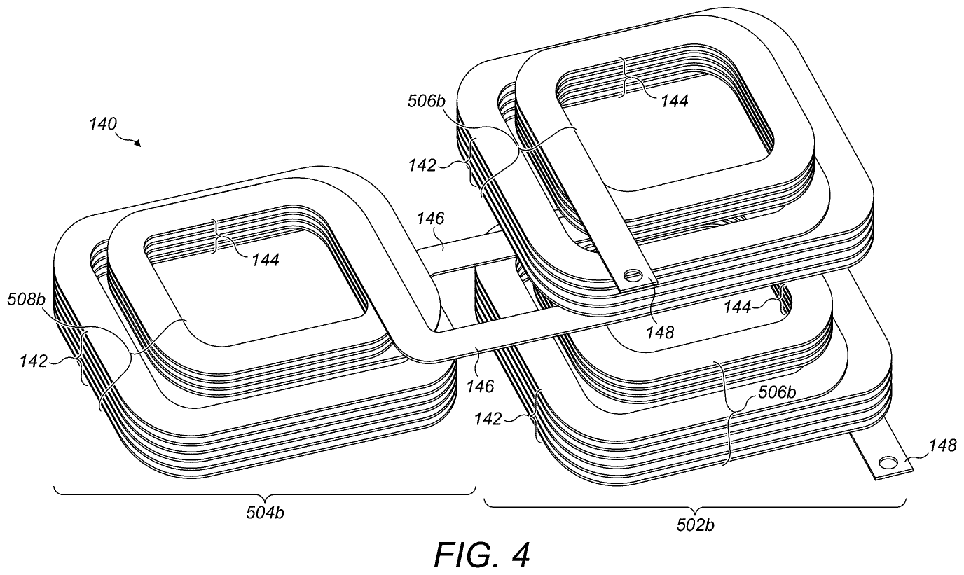

FIG. 2 is a side view of the first coil 120 in isolation. FIG. 3 is a perspective view showing the first section 130 of the first coil 120 in isolation. FIG. 4 is a perspective view showing the second section 140 of the first coil 120 in isolation. Put another way, the first section 130 shown in FIG. 3 is combined (interwound) with the second section 140 shown in FIG. 4, as will be described in more detail below, in order to form the first coil 120 shown in FIG. 2.

As shown in FIG. 3, the first section 130 of the first coil 120 is formed from a wire wound around a first winding axis and a second winding axis, forming a continuous electrically conductive path. The first winding axis and second winding axis are parallel or substantially parallel within manufacturing and/or measurement tolerances, and are laterally spaced apart. The wire may be a single piece of continuous wire, for example, flat wire as shown in FIG. 3.

The first section 130 includes one or more sets of turns 132 having a first diameter, and one or more sets of turns 134 having a second diameter. The first diameter is larger than the second diameter, such that when viewed along the first and second winding axes, the first sets of turns 132 and second sets of turns 134 are concentric, with the second sets of turns 134 located inside the diameter of the first sets of turns 132. Each set of turns includes one or more individual turns.

When moving along the wire of the first section 130, the path of the wire travels through each turn of one of the sets of turns 132 with the first diameter, and then travels through each turn of one of the sets of turns 134 with the second diameter. In the case of multiple sets of turns with the first and second diameters, the path of the wire then continues to travel through each turn of a second of the sets of turns 132 with the first diameter, and then travels through each turn of a second of the sets of turns 134 with the second diameter, and so on.

Put another way, the wire of the first section 130 alternates between the one or more sets of turns 132 with the first diameter and the one or more sets of turns 134 with the second diameter, when moving along the path of the wire. A final turn of each set of turns 132 with the first diameter is connected to a first turn of a respective set of turns 134 with the second diameter. The connections between the set of turns 132,134 may be referred to as a cross-over portions.

In the present example embodiment shown in FIG. 3, the first section 130 includes three sets of turns 132 having the first diameter, each including six individual turns. Further, the first section 130 includes three sets of turns 134 having the second diameter, each including four individual turns. The number of sets of turns with each diameter can vary, as can the number of turns within each set, and the above numbers for the example embodiment of FIG. 3 are for exemplary purposes only.

A first group 502a of the sets of turns 132,134 of the first section 130 are arranged around the first winding axis, and a second group 504a of the sets of turns 132,134 of the first section 130 are arranged around the second winding axis.

Specifically, in the present example embodiment, the wire of the first section 130 travels through a set of turns 132 with the first diameter and then a set of turns 134 with the first diameter both in the first group 502a, i.e., wound around the first winding axis. The wire of the first section 130 then travels through a set of turns 132 with the first diameter and then a set of turns 134 with the second diameter both in the second group 504a, i.e., wound around the second winding axis. In this way, the wire of the first section 130 alternates between the first group 502a and second group 504a when moving along the path of the wire, via the interconnections 136. Therefore, the wire of the first section 130 alternates between being wound around the first winding axis and wound around the second winding axis. This is referred to as a “zig-zag” arrangement herein, as the first section 130 zig-zags between the two winding axes.

The above description applies analogously to the second section 140 of the first coil 120, shown in FIG. 4. Namely, the second section 140 is formed from a wire wound parallel or substantially parallel, within manufacturing and/or measurement tolerances, around the first and second winding axes. The second section 140 includes one or more sets of turns 142 having the same first diameter as the first section 130, and one or more sets of turns 144 having the same second diameter as the first section 130. Each set of turns 142, 144 includes one or more individual turns. The wire of the second section 140 alternates between the one or more sets of turns 142 with the first diameter and the one or more sets of turns 144 with the second diameter, when moving along the path of the wire, with similar cross-over portions as described for the first section 130.

Like the first section 130, a first group 502b of the sets of turns 142,144 of the second section 140 are arranged around the first winding axis, and a second group 504b of the sets of turns 142,144 of the second section 140 are arranged around the second winding axis. The wire of the second section 140 alternates between the first group 502b and second group 504b when moving along the path of the wire, via the interconnections 146, using the same zig-zag arrangement as the first section 130.

The second section 140 differs in that the path of the wire starts at a set of turns 144 with the second diameter, rather than the set of turns 132 with the first diameter as is the case for the first section 130. In this way, the second section 140 can be thought of as the inverse of the first section 130.

The first section 130 of FIG. 3 and the second section 140 of FIG. 4 combine to form the first coil 120 shown in FIG. 2. In particular, the first section 130 and second section 140 are interwound around the same common winding axes (i.e., the first section 130 and second section 140 share the same first winding axis and second winding axis). Therefore, the first group 502a of the sets of turns 132,134 of the first section 130 and the first group 502b of the sets of turns 142,144 of the second section 140 are both wound around the same first winding axis, shown by line W1 in FIG. 2. Together, the first groups 502a,502b of the first and second sections 130,140 form the first group 502 of sets of turns of the first coil 120. Similarly, the second group 504a of the sets of turns 132,134 of the first section 130 and the second group 504b of the sets of turns 142,144 of the second section 140 are both wound around the same second winding axis, shown by line W2 in FIG. 2. Together the second groups 504a,504b of the first and second sections 130,140 form the second group 504 of sets of turns of the first coil 120.

As best seen in FIGS. 1 and 2, the first and second sections 130,140 are combined such that the sets of turns 134 of the first section 130 with the second diameter are positioned within respective sets of turns 142 of the second section 140 with the first diameter, when viewed along the winding axes. Similarly, the sets of turns 144 of the second section 140 with the second diameter are positioned within respective sets of turns 132 of the first section 130 with the first diameter, when viewed along the winding axes. By “positioned within” it is meant that each set of turns 134,144 with the second diameter is inside a respective set of turns 142,132 with the first diameter, and both are located within the same plane extending perpendicularly or substantially perpendicularly, within manufacturing and/or measurement tolerances, to the common winding axes.

Put another way, the sets of turns 132,142 having the first diameter and the sets of turns 134,144 having the second diameter are concentric about the first winding axis in the first group 502 of the first coil 120, when viewed along the first winding axis. Similarly, the sets of turns 132,142 having the first diameter and the sets of turns 134,144 having the second diameter are concentric about the second winding axis in the second group 504 of the first coil 120, when viewed along the second winding axis.

In some example embodiments, the sets of turns 132,142 having the first diameter of the first and second sections 130,140 fully overlap when viewed along the first and second winding axes, and the sets of turns 134,144 having the second diameter also fully overlap when viewed along the first and second winding axes. In other words, the first and second sections 130,140 have the same footprint.

Due to the zig-zag arrangement described above, the first and second sections 130,140 of the first coil 120 alternate together between the first group 502 and the second group 504 when moving along the path of the wire of the first coil. In the example embodiment of FIG. 2, the first coil 120 alternates between the first group 502 and the second group 504 twice (via two interconnections 136,146); however, any number of alternations may occur in general.

Put another way, the first group 502 and second group 504 of the first coil 120 may each include one or more subgroups 506,508, with the first and second sections 130,140 of the first coil 120 alternating between the subgroups 506 of the first group 502 and the subgroups 508 of the second group 504 when moving along the first coil 120. Each subgroup is therefore defined as the portions of the first and second sections 130,140 between a first interconnection 136,146 and the next interconnection 136,146 along the first coil 120 (i.e., between each alternation from the first group 502 to the second group 504). In other words, the subgroups 506 of the first group 502 are the portions of the first and second sections 130,140 between an incoming interconnection 136,146 from the second group 504 and an outgoing interconnection 136,146 to the second group 504. Similarly, the subgroups 508 of the second group 504 are the portions of the first and second sections 130,140 between an incoming interconnection 136,146 from the first group 502 and an outgoing interconnection 136,146 to the first group 502. For example, in the example embodiment of FIGS. 2 to 4, the first coil 120 includes two subgroups 506 in the first group 502 (formed by the subgroups 506a,506b in the first and second sections 130,150) and one subgroup 508 in the second group 504 (formed by the subgroups 508a,508b in the first and second sections 130,150).

The number of alternations between the first group 502 and second group 504 is necessarily one less than the number of subgroups 506,508. For example, in the example embodiment of FIGS. 2 to 4, there are three subgroups in total across both the first and second groups 502,504, and two alternations (interconnections 136,146) between the first and second group 502,540. In general, there can be any number of subgroups 506,508 in the first and second groups 502,504.

To summarize, the first coil 120 includes a first group 502 wound around a first winding axis, and a second group 504 wound around a second wining axis. Each of the first and second groups 502,504 may include one or more subgroups 506,508, with the first coil 120 (both the first and second sections 130,140) switching (zig-zagging) between a first subgroup of the first group 502, to a first subgroup of the second group 504, to a second subgroup of the first group 502, to a second subgroup of the second group 504, and so on.

This switching (zig-zag) arrangement between the first and second group results in an additional inductance, in the form of a leakage inductance, without the use of additional inductor components, imprecise litz wire, or the like. This is beneficial in various transformer applications. The exact leakage inductance can be improved or optimized depending on requirements by modifying the number of subgroups 506,508 in each group 502,504 (i.e., by modifying the number of switches/zig-zags between the first and second groups 502,504).

As shown in the example embodiment of FIGS. 2 to 4, the winding direction of the turns in the first group 502 of the first coil 120 around the first winding axis W1 may be in the opposite direction to the winding direction of the turns of the second group 504 of the first coil 120 around the second winding axis W2. This configuration advantageously means that the magnetic flux produced by the first and second groups 502,504 when a current flows through the first coil 120 will be in opposite directions for the first and second groups 502,504. Such a configuration is beneficial when the first coil 120 is used with a closed loop transformer core 200 such as that shown in FIG. 1.

In particular, when the first coil 120 is used with the transformer core 200 of FIG. 1, the first winding axis W1 and the second winding axis W2 extend along opposing first and second columns of the transformer core 200, such that the first group 502 of the first coil 120 is arranged around the first column of the transformer core, and the second group of the first coil 120 is arranged around the second column of the transformer core. With this arrangement, and opposite winding directions in the first and second group 502,504, the magnetic flux produced by the first and second groups 502,504 of the first coil 120 will advantageously follow the same direction around the closed loop of the transformer core 200 (e.g., clockwise).

However, in other example embodiments the same winding directions may be used for the first and second groups 502,504, depending on the type of transformer core used and the desired magnetic flux profile to be generated by the first coil 120.

Connection terminals 138 may be included at each end of the wire of the first section 130, for allowing an electrical connection to be made with the first section 130, as shown in FIG. 3. Similarly, connection terminals 148 may be included at each end of the wire of the second section 140, for allowing an electrical connection to be made with the second section 140, as shown in FIG. 4.

As mentioned above, the first section 130 and second section 140 of the first coil 120 may be electrically connected in parallel in some example embodiments. This electrical connection may be made via connecting or joining the connection terminals 138,148 of each of the first and second sections 130,140. In particular, the connection terminal 138 at a first end of the first section 130 and the connection terminal 148 at a first end of the second section 140 can be connected together, and the connection terminal 138 at a second end of the first section 130 and the connection terminal 148 at a second end of the second section 140 can be connected together.

Connecting the first section 130 and second section 140 in parallel is advantageous, as it means that the first coil 120 is able to handle higher currents, for example when acting as a primary coil for a transformer. The first coil 120 can handle higher current because each of the first and second sections 130,140 will only receive half of the input current due to the parallel connection.

In the present example embodiment, each subgroup 506,508 includes two sets of turns from each of the first and second sections 130,140: one set of turns 132,142 with first diameter, and one set of turns 134,144 with the second diameter. Put another way, in the present example embodiment within each subgroup 506,508 the first and second sections 130,140 each include one alternation (cross-over portion) between a set of turns 132,142 with the first diameter and a set of turns with the second diameter 134,144. However, in general each subgroup may contain any number of sets of turns, i.e., each subgroup may alternate between sets of turns with the first diameter and sets of turns with the second diameter any number of times within that subgroup.

Having no alternations (cross-over portions) between sets of turns with the first and second diameter within a subgroup is also possible. For example, in one example embodiment, each subgroup of the first group 502 may include one set of turns 132 having the first diameter from the first section 130 of the first coil 120, and one set of turns 144 having the second diameter from the second section 140 the first coil 120. Each subgroup of the second group 504 may include one set of turns 134 having the second diameter from the first section 130 of the first coil 120, and one set of turns 142 having the first diameter from the second section 140 the first coil 120.

Further, a combination of the example embodiments described above is possible. In other words, each subgroup may include a different number of sets of turns with the first and second diameter within that subgroup compared to other subgroups in the first coil 120.

In some example embodiments, the number of turns with the first diameter in the first section 130 is equal to the number of turns with the first diameter in the second section 140. Further, the number of turns with the second diameter in the first section 130 is equal to the number of turns with the second diameter in the second section 140. The first and second sections 130,140 of the first coil 120 therefore have the same length (ignoring any small differences caused by the cross-over portions between the sets of turns and the interconnections 136,146 between the first group 502 and the second group 504, which are typically negligible compared to the length of wire in the sets of turns). This means that the first section 130 and second section 140 advantageously have the same impedance, due to having the same length conductive path and same (inverse) shape.

In one specific example embodiment, the number of turns with the first diameter and the number of turns with the second diameter may be equal in the first section 130 of the first coil 120, and similarly the number of turns with the first diameter and the number of turns with the second diameter may be equal in the second section 140 of the first coil 120. However, as mentioned above, any number of turns may be used within each set of turns of the first and second section 103,140 in general. The number of turns may be tailored for the specific application.

Although a winding arrangement including only the first coil 120 may be used in some example embodiments, the first coil 120 may also be used in combination with a second coil 150, as shown in FIG. 1. As discussed above the first and second coils 120,150 typically form the primary and secondary coils of a transformer when used together.

The second coil 150 is largely the same as the first coil 120. In particular, the second coil 150 includes first and second sections 160,170 each including one or more sets of turns having the same first diameter as the first coil 120 and one or more sets of turns having the same second diameter as the first coil 120. A first group of the sets of turns of the first and second sections 160,170 of the second coil 150 are arranged around the same first winding axis as the first coil 120, and a second group of the sets of turns of the first and second sections 160,170 of the second coil 150 are arranged around the same second winding axis as the first coil 120.

The description above for the first coil 120 applies analogously to the second coil 150, and a repeated description will therefore be omitted. However, briefly, the first and second sections 160,170 of the second coil 150 may be electrically connected in parallel, similar to the first coil 120. The first and second sections 160,170 may be interwound in a similar fashion to the first coil 120, with concentric sets of turns with the first and second diameters. The first and second sections 160,170 alternate between subgroups of the first group of the second coil 150 and subgroups of the second group of the second coil 150, using the same zig-zag arrangement as described above for the first example embodiment. The first and second sections 160,170 of the second coil 150 may have the same length in some example embodiments.

The second coil 150 differs in that the second coil 150 includes a subgroup in the second group for each subgroup 506 in the first group 502 of the first coil, and the second coil 150 includes a subgroup in the first group for each subgroup 508 in the second group 504 of the first coil. In this way, the second coil 150 can be thought of as the inverse of the first coil 120. This allows the first and second coils 120,150 to mesh neatly together, as shown in FIG. 1 and described in more detail below, thus forming a dense winding arrangement which saves space.

For example, in the example embodiment of the first coil 120 described above, the first coil 120 includes two subgroups 506 in the first group 502 about the first winding axis W1, and one subgroup 508 in the second group 504 about the second winding axis W2. As seen in the example embodiment of FIG. 1, the second coil 150 includes one subgroup in the first group 502 about the first winding axis, and two subgroups in the second group 504 about the second winding axis.

Put another way, the second coil 150 may be identical to the first coil 120, except that the second coil 150 is rotated by 180° relative to the first coil 120 about an axis normal to the plane containing the first and second winding axes. Specifically, about the axis normal to the plane containing the first and second winding axes and positioned at the mid-point between the first and second winding axes and the mid-point along the height of the first and second coils. In such a case, the connection terminals of both the first and second coil 120,150 extend in the same direction, on the same side of the transformer core 200. This is the situation shown in FIG. 1.

Alternatively, the second coil 150 may be a 180° rotation of the first coil 120 about an axis parallel or substantially parallel, within manufacturing and/or measurement tolerances, to the first and second winding axes. Specifically, about the axis parallel or substantially parallel, within manufacturing and/or measurement tolerances, to the first and second winding axes that lies in the same plane as the first and second winding axes and is equidistant from the first and second winding axes. In this case the connection terminals of the second coil 150 would extend in the opposite direction to the connection terminals of the first coil 120, and on the opposing side of the transformer core.

Although in each of FIGS. 1 to 4 the connections terminals of both coils extend normally to the plane containing the first and second winding axes, the connection terminals may in general be folded so as to extend in any direction. For example, the connections terminals for the first coil 120 and/or second coil 150 may be folded to extend in a direction parallel or substantially parallel, within manufacturing and/or measurement tolerances, to the winding axes in some example embodiments.

In some example embodiments, the second coil 150 may be truly identical to the first coil 120, having the exact same total number of turns in each set of turns as the first coil 120 (i.e., the same number of turns with the first diameter, and the same number of turns with the second diameter). However, when such identical first and second coils 120,150 are used as the primary and secondary coils of a transformer, this would result in an isolation transformer only, with no step up or step down in voltage.

In other example embodiments, the first and second coil 120,150 are identical except for the number of turns within each set of turns. The arrangement of the second coil 150 is therefore the same as the first coil 120, and rotated by 180°, however the different number of turns in the second coil 150 can be selected to either step up or step down a voltage input into the first coil 120.

When used together the first coil 120 and second coil 150 are wound together around the first and second winding axes, as shown in FIG. 1 in particular. Similarly to the first coil 120, when the second coil 150 is used with the transformer core 200 of FIG. 1, the first winding axis W1 and the second winding axis W2 of both coils 120,150 extend along opposing first and second columns of the transformer core 200, such that the first groups of the first and second coils 120,150 are arranged around the first column of the transformer core, and the second groups of the first and second coils 120,150 are arranged around the second column of the transformer core.

The first and second coils 120,150 are interwound such that the subgroups 506,508 of the first coil 120 and the subgroups of the second coil 150 alternate when moving along both the first winding axis and the second winding axis. In other words, the subgroups 506 of the first coil 120 are stacked in an alternating fashion with the subgroups of the second coil 150 in the first group 502 along the first winding axis. Similarly, the subgroups 508 of the first coil 120 are stacked in an alternating fashion with the subgroups of the second coil 150 in the second group 504 along the second winding axis. Such an arrangement is beneficial in mitigating losses due to the proximity effect, as well as advantageously introducing the additional leakage induction.

In some example embodiments, including that shown in FIG. 1, the first coil 120 and the second coil 150 fully overlap when viewed along the first and second winding axes. In particular, the first and second sections 130,140,160,170 of both coils 120,150 fully overlap when viewed along the first and second winding axes. In other words, the first coil 120 and the second coil 150 have the same footprint.

As with the first coil 120, in the present example embodiment the winding direction of the sets of turns in the second coil 150 about the first winding axis (in the first group) is opposite to the winding direction of the sets of turns of second coil 150 about the second winding axis (in the second group). Having opposite winding directions in the first and second group of the second coil 150 mean that a closed loop of magnetic flux produced by the first coil 120 around the closed loop of the transformer core 200 (e.g., in a clockwise direction) will advantageously induce a current traveling in the same direction along the wire of the second coil 150.

Further, as shown in FIG. 1, the transformer may have a subtractive polarity, with the sets of turns of the second coil 150 in the first group (about the first winding axis W1) having a winding direction opposite to the sets of turns of the first coil 120 in the first group 502, and the sets of turns of the second coil 150 in the second group (about the second winding axis W2) having a winding direction opposite to the sets of turns of the first coil 120 in the second group 504.

In alternative example embodiments, an additive polarity may also be used, with the sets of turns of the first and second coils 120,150 in the first group (about the first winding axis W1) having the same winding direction, and the sets of turns of the first and second coils 120,150 in the second group (about the second winding axis W2) having the same winding direction.

As mentioned, as well as using the first coil 120 in combination with second coil 150, the first coil 120 may also be used in isolation, for example with each section 130,140 of the first coil 120 forming the primary or secondary coil of a transformer.

In another example embodiment, the first coil 120 could be used in combination with a one or more secondary coils, where each secondary coil is only wound around one of the first or second winding axes. Analogously to the first coil 120, each secondary coil may include one or more sets of turns with the first diameter and one or more sets of turns with the second diameter, however all sets of turns of the secondary coil are arranged around a single one of the winding axes. Further, each secondary coil may include two sections connected in parallel, with concentric sets of turns with the first and second diameter, analogously to the first coil 120.

In all of the above-described example embodiments, the turns of each of the first and second coils 120,150 have a square shape about the winding axes. However, in general a rectangular, square, or circular shape, or various other shapes may also be used. Typically, the turns of the first coil 120 and second coil 150 have the same shape. Each set of turns of each of the first and second coils 120,150 is arranged (wound) helically around the first or second winding axis.

In general, any of the winding arrangements described herein may be used in a sealed winding unit. For example, the first coil 120 and/or second coil 150 may encased in a potting material in some example embodiments. When both the first and second coils 120,150 are present, the coils may be potted together to form a single integral winding unit.

The winding arrangements of each of the example embodiments described above (i.e., both the first coil 120 and second coil 150) are formed from flat wire. However, in some example embodiments other types of wire may also be used, such as round wire windings or the like.

The wire used in the winding arrangements of each of the example embodiments may be formed from various electrically conductive materials, such as copper or the like. However, in an example embodiment of the present invention, the wire used in the first coil 120 and/or the second coil 150 is formed from aluminum wires, for example, aluminum flat wires. The use of aluminum as the conductive material in the windings has a number of benefits, particularly in larger, high-frequency transformers, which are becoming more prevalent due to new applications such as use in electric vehicles. Firstly, aluminum has a lower density than traditional conductors such as cooper, and therefore leads to weight savings. Moreover, aluminum is cheaper than traditional conductors such as copper, leading to a lower manufacturing cost.

Secondly, carefully selected design parameters can be used with the aluminum windings to provide further benefits. The size of the thickness of the wire conductor is selected to be thicker than twice the skin depth of aluminum. This slight oversizing of the aluminum conductor means that there is an unused area within the center of the aluminum conductor (unused in the sense that it contains a very low or zero current density). The majority of the current carried by an aluminum flat wire conductor is therefore located within the outer area close to the surface of the wire.

Therefore, a central volume with a very low or zero current density runs along the entire length of the aluminum conductor. This central volume acts as a cooling channel running through the aluminum conductor itself, to allow heat generated within the aluminum conductor to travel along and eventually out of the aluminum conductor. In other words, the size of the aluminum conductor is chosen to make a positive use of the skin depth and proximity effect in the aluminum conductor.

In a particular example embodiment, the flat wire has a width of between about 10 mm and about 15 mm, and a thickness of between about 0.8 mm and about 1.2 mm, for example. The thickness of the flat wire can be about 1 mm, for example. The width and thickness directions are the directions perpendicular to the direction of the extension of the wire, i.e., perpendicular to the direction the current flows in. The width direction is the larger dimension of the wire perpendicular to the extension of the wire, and the thickness direction is the smaller dimension of the wire perpendicular to the extension of the wire.

In a first example embodiment, the flat wire has a width of 15 mm±2 mm, and a thickness of 1.0 mm±0.2 mm, for example. In a second example embodiment, the flat wire has a width of 10 mm±2 mm, and a thickness of 1.0 mm±0.2 mm, for example.

The dimensions of the flat wire above may be used with any conductive material, such as copper. However, the dimensions above are specifically tailored to achieve the maximal beneficial effects, such as the cooling benefit, when aluminum is used as the conductive material.

In some example embodiments, a mix of conductive materials may be used, for example different conductive materials may be used in each of the first and second coils 120,150.

In general, the above-described concepts and example embodiments may be applied to all high-power, high-frequency transformers, including those with higher or lower power ratings than 50 kW. Moreover, the concepts described herein could also be used in high power inductors or the like.

In use in a transformer, the connection terminals of the primary coil of the winding arrangements described above (for example, the first coil 120 with the first and second sections 130,140 connected in parallel) act as input terminals for an alternating current (AC) voltage source. This will result in an AC voltage being produced at the connection terminals of the secondary coil (for example, the second coil 150 with the first and second sections 160,170 connected in parallel). In other words, the connection terminals of the secondary coil act as output terminals. A load may be connected across said output terminals. In some example embodiments, by varying the number of turns in each coil, a step-up or step-down in voltage can be achieved.

The number or turns shown in the drawings and given as examples in the description above are for exemplary purposes only. In general, in each example embodiment, various different numbers of turns may be used in each coil.

A transformer according to example embodiments of the present invention may be used individually or as a bank of connected or unconnected transformers. Transformers according to example embodiments of the present invention may be used in various applications, such as use in a vehicle, for example in a regenerative braking system, or in power generation equipment, particularly in renewable energy systems, or in DC-DC converters, power inverters, radio frequency electronic equipment, or in miniature scale transformers. It is noted that this list is not intended to be exhaustive, and that other applications are also contemplated.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A winding arrangement for an electrical transformer, the winding arrangement comprising:
a first coil including a first section and a second section; wherein
the first and the second sections of the first coil each include one or more sets of turns having a first diameter and one or more sets of turns having a second diameter smaller than the first diameter;
the winding arrangement includes a first winding axis and a second winding axis parallel or substantially parallel to the first winding axis; and
a first group of sets of turns of the first and the second sections of the first coil are arranged around the first winding axis, and a second group of sets of turns of the first and the second sections of the first coil are arranged around the second winding axis.

2. The winding arrangement of claim 1, wherein the first section and the second section of the first coil are electrically connected in parallel.

3. The winding arrangement of claim 1, wherein
a number of turns having the first diameter in the first section of the first coil is equal to a number of turns having the first diameter in the second section of the first coil, and a number of turns having the second diameter in the first section of the first coil is equal to a number of turns having the second diameter in the second section of the first coil, such that the first and the second sections of the first coil have a same length.

4. The winding arrangement of claim 1, wherein, when viewed along the first and the second winding axes:
each set of turns of the first section of the first coil having the second diameter is positioned within a respective set of turns of the second section of the first coil having the first diameter; and
each set of turns of the second section of the first coil having the second diameter is positioned within a respective set of turns of the first section of the first coil having the first diameter.

5. The winding arrangement of claim 1, wherein
in the first group of the first coil, the sets of turns having the first diameter and the sets of turns having the second diameter are concentric about the first winding axis; and
in the second group of the first coil, the sets of turns having the first diameter and the sets of turns having the second diameter are concentric about the second winding axis.

6. The winding arrangement of claim 1, wherein the first and the second sections of the first coil alternate between the first group and the second group one or more times along the first coil.

7. The winding arrangement of claim 1, wherein the first group and the second group of the first coil each include one or more subgroups, and the first and the second sections of the first coil alternate between the one or more subgroups of the first group and the one or more subgroups of the second group along the first coil.

8. The winding arrangement of claim 7, wherein each subgroup of the one or more subgroups of the first coil includes:
one set of turns having the first diameter and one set of turns having the second diameter both from the first section of the first coil; and
one set of turns having the first diameter and one set of turns having the second diameter both from the second section of the first coil.

9. The winding arrangement of claim 7, wherein each subgroup of the one or more subgroups of the first coil includes either:
one set of turns having the first diameter from the first section of the first coil and one set of turns having the second diameter from the second section of the first coil; or
one set of turns having the second diameter from the first section of the first coil and one set of turns having the first diameter from the second section of the first coil.

10. The winding arrangement of claim 1, wherein
a number of turns having the first diameter and a number of turns having the second diameter are equal in the first section of the first coil; and
a number of turns having the first diameter and a number of turns having the second diameter are equal in the second section of the first coil.

11. The winding arrangement of claim 1, wherein a winding direction of the first group of the first coil around the first winding axis is in an opposite direction to a winding direction of the second group of the first coil around the second winding axis.

12. The winding arrangement of claim 1, further comprising:
a second coil including a first section and a second section; wherein
the first and the second sections of the second coil each include one or more sets of turns having the first diameter and one or more sets of turns having the second diameter; and
a first group of sets of turns of the first and the second sections of the second coil are arranged around the first winding axis, and a second group of sets of turns of the first and the second sections of the second coil are arranged around the second winding axis.

13. The winding arrangement of claim 12, wherein the first and the second sections of the second coil are electrically connected in parallel.

14. The winding arrangement of claim 1, wherein the first group and the second group of the second coil each include one or more subgroups, and the first and the second sections of the second coil alternate between the one or more subgroups of the first group and the one or more subgroups of the second group along the second coil.

15. The winding arrangement of claim 14, wherein the first and the second coils are interwound such that the one or more subgroups of the first coil and the one or more subgroups of the second coil alternate along both the first winding axis and the second winding axis.

16. The winding arrangement of claim 12, wherein the first coil and the second coil fully overlap when viewed along the first and the second winding axes.

17. The winding arrangement of claim 12, wherein either:
the first and the second coils are identical; or
the first and the second coils are identical other than a number of turns within the first and the second coils.

18. The winding arrangement of claim 12, wherein the second coil is rotated by 180° relative to the first coil about either an axis parallel or substantially parallel to the first and the second winding axes, or an axis normal to the plane containing the first and the second winding axes.

19. The winding arrangement of claim 1, wherein each set of turns of the first coil is arranged helically around the first or the second winding axis.

20. The winding arrangement of claim 1, wherein turns of the first coil have a rectangular, square, or circular shape about the first or the second winding axis.

21. The winding arrangement of claim 1, wherein the first coil includes aluminum wire.

22. The winding arrangement of claim 1, wherein the first coil includes flat wire.

23. The winding arrangement of claim 1, wherein the first coil is encased in a potting material.

24. An electrical transformer comprising:
a transformer core; and
the winding arrangement of claim 1 arranged around the transformer core.

25. The electrical transformer of claim 24, wherein the first winding axis and the second winding axis extend along opposing columns of the transformer core.
